(19) United States
(12) Patent Application Publication
(10) Pub. No.: US 2024/0092567 A1
(43) Pub. Date: Mar. 21, 2024

(54) A SYSTEM AND A METHOD FOR MONITORING CONTENT OF A WASTE CONTAINER

(71) Applicant: BinSense Pty Ltd, Brabham (AU)

(72) Inventors: Narendran Subramaniam, Brabham (AU); Joshua Letcher, Brabham (AU)

(21) Appl. No.: 17/768,806

(22) PCT Filed: Oct. 14, 2020
(86) PCT No.: PCT/AU2020/051104

§ 371 Date: Apr. 13, 2022

(30) Foreign Application Priority Data
Oct. 14, 2019 (AU) 2019903856

(51) Int. Cl. B65F 1/14; G06Q 10/30

(52) U.S. Cl. CPC B65F 1/1484; G06Q 10/30; B65F 2210/128; B65F 2210/1443; B65F 2210/152; B65F 2210/168; B65F 2210/172

(57) ABSTRACT

The present invention relates to a system and a method for monitoring content of a waste container. The system comprises at least one monitoring device comprising a gas sensor for detecting a concentration of at least one gas within a waste container. The system is configured such that when the at least one monitoring device is mounted to the waste container, the monitoring device is configured to communicate information indicative of the detected gas concentration within the waste container via the network interface to a remote computing device such that the system can determine whether the detected concentration of the at least one gas within the waste container exceeds or falls below a pre-determined threshold.

### TECHNICAL FIELD

The present invention relates to a system and a method for monitoring content of a waste container. In particular, but not exclusively, the present invention relates to a system and a method for monitoring content of a plurality of recycling waste containers.

### BACKGROUND

Waste collection is part of the waste management process. Residential and commercial waste containers are typically collected from a location of use and then transferred for waste disposal and further processing, such as recycling. In Australia and other countries, specific waste such as paper, glass and certain plastics needs to be separated from other waste and collected in a waste container specific for recyclable waste, such as the yellow or green recycling bin.

A problem arises when incorrect and not recyclable items, such as organic and food waste, are collected in the recycling waste container. This is commonly referred to as contamination. Currently, up to 20% of household kerbside recycling cannot be recycled because of issues in relation to contamination. Even more so, one contaminated waste container may cause contamination of an entire waste collection vehicle which is then typically offloaded in landfill.

It would therefore be advantageous if at least an embodiment of the present invention overcame this problem or at least provided a workable solution in relation to the contamination of waste containers.

Any discussion of documents, acts, materials, devices, articles or the like which have been included in the present specification is not to be taken as an admission that any or all of these matters form part of the prior art base or were common general knowledge in the field relevant to the present invention as it existed before the priority date of each claim of this application.

Throughout the specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

Embodiments of the present invention relate to a system for monitoring content of a waste container, the system comprising:
at least one monitoring device comprising a gas sensor for detecting a concentration of at least one gas within a waste container, the at least one monitoring device further comprising a controller in communication with the gas sensor and a network interface;
wherein the system is configured such that when the at least one monitoring device is mounted to a waste container, the controller of the at least one monitoring device is configured to communicate information indicative of the concentration of at least one gas within the waste container via the network interface to a remote computing device such that the system can determine whether the detected concentration of the at least one gas within the waste container exceeds or falls below a pre-determined threshold.

Embodiments of the present invention provide significant advantages. In particular, the system may detect if any decomposable content is located within the waste container so that the system can make a determination whether the waste container, such as a recycling bin, is contaminated with bio or organic waste and therefore cannot be collected for further processing.

In some embodiments, the system may comprise a plurality of monitoring devices, each being configured to mount to a respective waste container, such as to a lid of a waste container. These embodiments are particularly applicable when residential or commercial recycling waste containers are to be monitored for contamination.

In an embodiment, each monitoring device may be associated with identification information. In this regard, the monitoring device may comprise a storage element for storing the identification information. The controller of the monitoring device may be configured to communicate the identification information to the remote computing device, for example, together with the information indicative of the gas concentration. In this way, the system may identify a household associated with the waste container on which the monitoring device is mounted.

It should be understood that the storage element of the at least one monitoring device may store any suitable information, including but not limited to the detected concentration of the at least one gas. For example, multiple readings of the gas concentration within the waste container over a period of time may be stored in the storage element.

In an embodiment, the system may be configured to determine a level of contamination within the waste container using the detected concentration of the at least one gas within the waste container. A person skilled in the art will appreciate that any suitable component of the system may process the information to determine the level of contamination, including but not limited to the controller of the at least one monitoring device or the remote computing device.

In an embodiment, the system may be configured such that if the system determines that the detected concentration of the at least one gas within the waste container exceeds or falls below the pre-determined threshold, the at least one monitoring device may automatically transmit the identification information associated with the waste container to the remote computing device. In this regard, the remote computing device may be an administrator system that is configured to further process the information.

Specifically, the system may be configured such that the identification information can be made available to a driver of a waste collection vehicle. For example, the administrator system may process the information and make the processed information available to a driver computing device associated with the waste collection vehicle via the network interface. In this way, waste containers that are contaminated with bio or food waste can be identified by the driver of the waste collection vehicle and may not be collected.

The identification information may comprise a unique identifier, such as a unique number identifying the or each monitoring device. The system may be configured to identify a household associated with the monitoring device using the unique identifier, for example, by accessing a database in which each unique identifier is linked to a household. Alternatively, the identification information may comprise information indicative of the household, such as name and address of the household.

In an embodiment, the gas sensor may be configured to determine a concentration of at least methane within the waste container. Methane levels exceeding a predetermined threshold may be indicative of the waste container being contaminated with composable waste, such as bio or food waste.

In an embodiment, the gas sensor may be configured to determine a concentration of oxygen within a waste container. Oxygen levels below a predetermined threshold may be indicative of the waste container being contaminated with composable waste, such as bio or food waste.

The gas sensor may be any suitable type of gas sensor, including but not limited to a combustible gas sensor, a photoionisation detector, an infrared point sensor, an ultrasonic sensor, an electrochemical gas sensor, a semiconductor sensor and an infrared imaging sensor.

In a specific embodiment, the at least one monitoring device may further comprise a distance sensor configured to detect a distance to the content within the waste container. In this way, the system may determine information indicative of a fill level of the waste container. Additionally or alternatively, the system may use the detected distance to determine whether a lid of the waste container is substantially closed.

The distance sensor may be in the form of a light detection and ranging (LIDAR) sensor. A LIDAR sensor typically comprises a light source for emitting light to the content within the waste container and a detector for detecting light reflected by the content. The detected light is then used to determine a distance from the sensor to the content. A person skilled in the art will appreciate that LIDAR modules are well known in the art and will not be described in further detail in this application. Alternatively, the distance sensor may be in the form of an ultrasonic distance sensor. An ultrasonic distance sensor typically comprises a transducer for emitting sound waves and detecting sound waves reflected by the content within the waste container.

In an embodiment, the system may use the detected distance to determine a shape of a content item within the waste container. In addition, information indicative of the shape of a content item may be used to identify a property associated with the content item, such as a material or a type of the content item. In this regard, the system may use a learning algorithm to identify the property associated with the content item within the waste container.

In an embodiment, a monitoring device may further comprise a temperature sensor configured to measure a temperature within the waste container.

In an embodiment, the system may further comprise at least one receiver configured to receive information from the at least one monitoring device when the at least one monitoring device is located within a pre-defined distance from the receiver. In this regard, the system may be configured to facilitate wireless communication between the at least one monitoring device and the receiver. Suitable wireless communication technologies include but are not limited to Bluetooth, near field, Wi-Fi, RFID, and radio frequency (RF). In a specific embodiment, the system may be configured to facilitate wireless communication using Long Range (LORA). In this regard, the network interface of the at least one monitoring device may comprise a LORA module. Using LORA has the specific advantages that LORA has a relatively low power usage and may additionally have geolocation capabilities to determine a position of the monitoring device using triangulation.

In an embodiment, the receiver may be positioned stationary such that one or more monitoring devices are located within the pre-defined distance from the receiver. For example, a receiver may be arranged on a lamp post, a cell tower or the like. This may be particularly applicable for technologies such as LORA or RF. Additionally or alternatively, a receiver may be positioned on a moving object, such as on a waste collection vehicle. A person skilled in the art will appreciate that a receiver may not be necessary when using certain communication technologies, such as Wi-Fi. In this case, each monitoring device may communicate information directly to the administrator system using each household's Wi-Fi network. Further, a person skilled in the art will appreciate that the receiver may be part of a remote computing device, such as a smartphone, a tablet or the like. In this case, the remote computing device may communicate directly with the or each monitoring device.

In an embodiment, the system may be configured to transmit information to the remote computing device or the receiver via the network interface continuously, periodically and/or on request. For example, the at least one monitoring device may detect the concentration of the at least one gas periodically and may store the information indicative of the detected concentration over a period of time on a storage element. The system may be configured to transmit multiple readings that have been stored on the storage element to the remote computing device at one time, for example, once a day, once a week, one a fortnight or the like. In embodiments that comprise a receiver, the system may be configured such that when the receiver moves within the pre-defined distance relative to the at least one monitoring device, the at least one monitoring device automatically communicates information indicative of multiple readings to the receiver.

In an embodiment, the system may further be configured to determine a real-time position of the at least one monitoring device. For example, the system may use signal strength and signal frequency of the wireless communication between the at least one monitoring device and a receiver to determine the real-time position of the at least one monitoring device. The real-time position may be determined absolute or relative to the receiver. For example, if the network interface of the at least one monitoring device comprises a Wi-Fi module, the receiver may use a signal strength and a signal frequency of the WiFi signal to calculate a relative distance to the receiver. In a further example, the network interface of the at least one monitoring device comprises a LORA module and the system may calculate a position of the at least one monitoring device by applying a multilateration algorithm on the gateway timestamps received from the receiver. Alternatively, the at least one monitoring device may further comprise a positioning sensor to determine a real-time position of the monitoring device and thereby the waste container when the at least one monitoring device is mounted to the waste container. The positioning sensor may be in the form of a GPS sensor.

In an embodiment, the at least one monitoring device may comprise a mount for mounting the monitoring device to the waste container, such as a lid of the waste container. In one example, the at least one monitoring device comprises a housing having two housing parts such that the monitoring device is mounted to the waste container by positioning a portion of the lid of the waste container between the two housing parts. The two housing parts may be connected in any suitable way, such as by virtue of a mechanical fastener and/or an adhesive.

The at least one monitoring device may further comprise a power source to provide power to the one or more sensors and the controller. The power source may be any suitable power source, such as a battery and/or solar cells. For example, the at least one monitoring device may be configured such that when the at least one monitoring device is mounted to the waste container, one or more solar cells are positioned on an outer portion of the waste container and at least the gas sensor and the controller are positioned on an inner portion of the waste container.

In an embodiment, the controller of the at least one monitoring device is configured to determine whether the detected concentration of the at least one gas within the waste container exceeds or falls below a pre-determined threshold. Further, the controller may determine a level of contamination within the waste container.

The system may be configured to communicate any suitable information from the at least one monitoring device to the remote computing device. The remote computing device may be an administrator computing device to make information available to an administrator, a driver computing device to make information available to a driver of a waste collection vehicle and/or a household computing device to make information available to a household. In general, the remote computing device may be in the form of any communication enabled computing device, such as a smartphone, a tablet computer, a personal computer, a laptop computer or a PDA.

The system may be configured to display information indicative of the identified waste container and the detected gas concentration on a display of the remote computing device. A person skilled in the art will appreciate that the display may be configured to display only quantitative information indicating whether the detected gas concentration exceeds or falls below the predetermined threshold. The display may additionally display any other suitable information, including but not limited to identification information, such as a name of the household associated with the waste container, an address of the household associated with the waste container, a map indicating a position of the waste container, a map indicating a position of the waste container relative to the receiver, information indicative of a fill level of the waste container, information indicative whether the lid of the waste container is closed, and historical data. A person skilled in the art will appreciate that the information may be tailored to the specific user of the computing device, such as an administrator, a driver of a waste collection vehicle or a household.

In an embodiment, the system may be configured to automatically trigger an action in response to the detected gas concentration within the waste container. For example, depending on the detected gas concentration, one of a plurality of actions may be automatically triggered. An action may, for example, be to automatically communicate a written warning to the household associated with the monitoring device, to issue a fine to the household associated with the monitoring device, non-collection of the waste container and/or to communicate a notification of the non-collection. The action may be in the form of information being transmitted to the driver computing device and/or the household computing device.

If the system determines that the detected gas concentration within a waste container exceeds or falls below a predetermined gas concentration, the system may be configured to make available information indicative of this to the household associated with the waste container. In this regard, the system may communicate a notification to the household in any suitable way, such as to the household computing device.

In an embodiment, the system may use the information indicative of the fill level of each waste container to dynamically generate a route for the waste collection vehicle. The system may be configured to render a map of the generated route and display the map on the display of the driver computing device.

Embodiments of the present invention relate to a monitoring device for monitoring content of a waste container, the monitoring device comprising:
a mount for mounting the monitoring device to the waste container;
a gas sensor for detecting a concentration of at least one gas within the waste container;
a controller in communication with the gas sensor; and
a power source for providing power to at least the controller;
wherein the monitoring device is configured such that the controller processes the detected concentration of the at least one gas by the gas sensor to determine whether the detected concentration of the at least one gas within the waste container exceeds or falls below a pre-determined threshold.

In further embodiments, the monitoring device may comprise any suitable additional sensors, such as a distance sensor and/or a temperature sensor as described in detail above. The monitoring device may further comprise a network interface such that information can be transmitted to a remote computing device.

An embodiment of the present invention relates to a system for monitoring content of a waste container, the system comprising:
a monitoring device comprising,
   a gas sensor for detecting a concentration of at least one gas within a waste container;
   a controller in communication with the gas sensor and configured to determine whether the detected concentration of the at least one gas exceeds or falls below a predetermined threshold; and
   a network interface;
wherein the system is configured such that when a monitoring device is mounted to a waste container and the controller of the sensor device determines that the detected concentration of the at least one gas within the waste container exceeds or falls below the pre-determined threshold, the controller automatically communicates via the network interface information indicative of the detected gas concentration within the waste container to a remote control system.

This embodiment may be particularly advantageous for waste containers that are not monitored regularly. For example, the detected gas concentration being above or below a pre-determined threshold may indicate that the waste container emits an unpleasant smell. By automatically communicating this information to the remote control system, an action may be initiated, such as the immediate collection of the content of the waste container.

Embodiments of the present invention relate to a computer implemented method of monitoring content of a waste container, the method comprising:
detecting a concentration of at least one gas within the waste container using a monitoring device mounted to the waste container;
communicating via a network interface of the monitoring device information indicative of the at least one gas concentration to a remote computing device; and
determining by a processor whether the detected concentration of the at least one gas within the waste container exceeds or falls below a pre-determined threshold.

In an embodiment, the method may comprise a step of determining a level of contamination within the waste container.

In an embodiment, the method may comprise a step of detecting a distance from the monitoring device to a content within the waste container using the monitoring device, and determining information indicative of a fill level of the waste container using the detected distance.

In a further embodiment, the method may comprise measuring a temperature within the waste container using the monitoring device.

The method may further comprise a step of processing the information to display the processed information on a display of a remote computing device.

In accordance with embodiments of the present invention, there is provided a software application for monitoring content of a waste container, the software application when executed on a computer system performing the steps of the above described method.

It will be appreciated by persons skilled in the art that numerous variations and/or modifications may be made to the invention as shown in the specific embodiments and/or aspects without departing from the spirit or scope of the invention as broadly described. For example, it will be apparent that certain features of the invention can be combined to form further embodiments. The present embodiments and aspects are, therefore, to be considered in all respects as illustrative and not restrictive. Several embodiments are described above with reference to the drawings. These drawings illustrate certain details of specific embodiments that implement the systems and methods and programs of the present invention. However, describing the invention with drawings should not be construed as imposing on the invention any limitations associated with features shown in the drawings.

### BRIEF DESCRIPTION OF DRAWINGS

Certain exemplary embodiments of the present invention will now be described, by example only, with reference to the accompanying drawings in which:

FIG. 1 is a schematic representation of system for monitoring content of a plurality of waste containers in accordance with an embodiment of the present invention;

FIG. 2 is a schematic representation of monitoring device of the system of FIG. 1;

FIG. 3 is a schematic representation of an administrator system of the system of FIG. 1;

FIG. 4 is a schematic representation of an alternative monitoring device of a system for monitoring content of a plurality of waste containers in accordance with a further embodiment of the present invention;

FIG. 5 shows components of an exemplary monitoring device and a receiver in accordance with a further embodiment of the present invention; and

FIG. 6 shows a flow chart illustrating a method of monitoring content of a plurality of waste containers in accordance with an embodiment of the present invention.

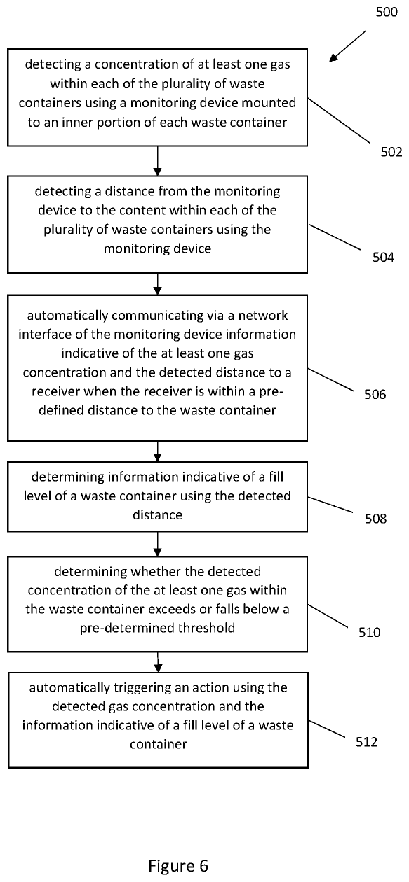

### DESCRIPTION OF EMBODIMENTS

Embodiments of the present invention generally relate to a system and a method for monitoring content of a waste container, for example, of a plurality of waste containers. The system comprises at least one monitoring device comprising a gas sensor for detecting a concentration of at least one gas within a waste container. The monitoring device further comprises a controller and a network interface. The system is configured such that when the at least one monitoring device is mounted to a waste container, such as a lid, the controller of the monitoring device can communicate information indicative of the gas concentration within the waste container via the network interface to a remote computing device. The controller of the monitoring device may communicate the information periodically, continuously and/or upon request. The system may then determine whether the detected concentration of the at least one gas within the waste container exceeds or falls below a pre-determined threshold. For example, the system may determine a level of contamination within the waste container.

In some embodiments, the system further comprises a receiver configured to receive information from the at least one monitoring device. The receiver may be a stand-alone device or alternatively may be part of a computing device. In some embodiments, the receiver may be arranged stationary within a pre-defined distance from the at least one monitoring device. Alternatively, the receiver may be moveable and the information may be automatically communicated from the at least one monitoring device to the receiver if the receiver moves within a pre-defined distance from the at least one monitoring device.

Embodiments of the present invention provide significant advantages. In particular, the system may determine the gas concentration within a waste container in real-time. The detected gas concentration may be used to determine whether the waste container is contaminated. Specifically, the system may use the detected gas concentration to calculate a level of contamination. For example, in the case of a recycling waste container, the gas concentration may indicate whether the waste container is contaminated, i.e. contains any organic or food waste. In this way, the system may facilitate a decision-making process whether to collect the waste container for recycling or leave it uncollected based on the detected gas concentration. As a consequence, contaminated waste collections may be significantly reduced or even avoided.

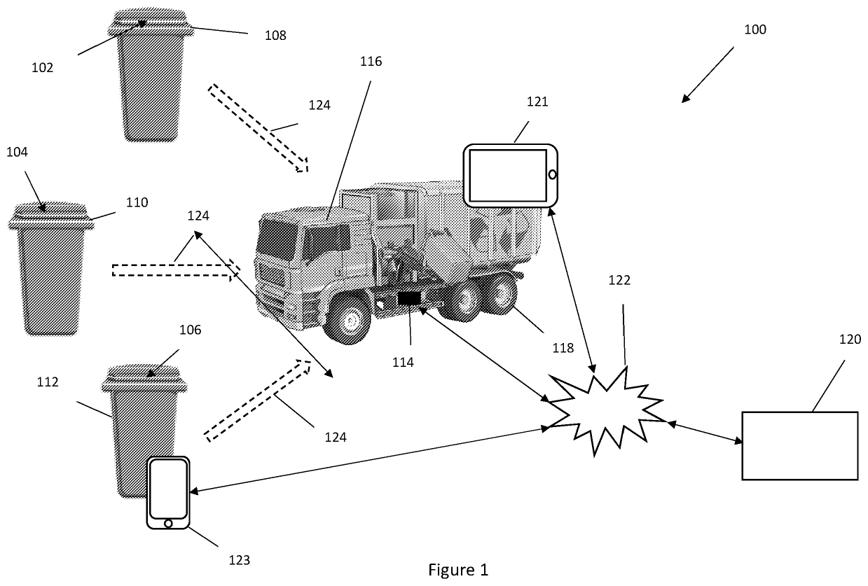

Referring now to FIG. 1 of the accompanying drawings, there is shown a system 100 for monitoring content of a plurality of waste containers in accordance with an embodiment of the present invention. In this particular example, the system 100 is suitable for monitoring the content of waste containers for collecting recyclable waste. The computer system 100 comprises a plurality of monitoring devices 102, 104, 106, each of which is mounted to a respective recycling waste container 108, 110, 112, in this example to an inner portion of the lid of each waste container 108,110, 112.

The system 100 further comprises a receiver 114 which in this example is mounted to a waste collection vehicle 118. The receiver 114 is configured to receive information from each of the monitoring devices 102, 104, 106 and to transmit the received information to a remote computing device through a communications network, such as the Internet 122. The remote computing device may be any suitable communications enabled computing device, such as a computer server for processing data and/or making information available to a user. For example, the remote computing device may be an administrator system 120, a driver computing device 121 associated with a waste collection vehicle or a household computing device 123 associated with a household of a waste container, such as waste container 112.

The receiver 114 in this particular example is in the form of an electronic stand-alone device specifically configured for this embodiment of the present invention. However, a person skilled in the art will appreciate that any communications enabled computing device that is capable of communicating with the plurality of monitoring devices 102, 104, 106 is envisaged, including but not limited to a smartphone, a tablet computer, a personal computer, a laptop computer, a PDA or a computing device specifically configured for the present invention. For example, the receiver may form part of one of the remote computing devices 120, 121, 123.

In a further example (not shown), a stand-alone receiver 114 may be positioned stationary within a pre-defined distance from the plurality of monitoring devices 102, 104, 106. In this way, continuous communication between the receiver 114 and the plurality of monitoring devices 102, 104, 106 may be possible if desired.

Each monitoring device 102, 104, 106 comprises a controller and a network interface and the system 100 is configured such that the receiver 114 can detect and identify a monitoring device 102, 104, 106 when the monitoring device 102, 104, 106 is located within a pre-defined distance from the receiver 114. This may be implemented through a short or long range wireless communications technology, such as WiFi, Bluetooth, Radio, RF, LoRa or the like. The pre-defined distance may range from 100 m to 1 km, and in particular from 200 m to 600 m, or from 250 m to 500 m, or of approximately 100 m, 200 m, 300 m, 400 m or 500 m. A person skilled in the art will appreciate that the pre-defined distance may vary depending on whether there are any obstructions in the line of sight. Moreover, the pre-defined distance may be defined based on other characteristics of the wireless communication components, including but not limited to frequency, antenna and power output.

In this example in which the receiver 114 is mounted to a moving object, once the receiver 114 is within the pre-defined distance, the monitoring devices 102, 104, 106 automatically send at least information indicative of a gas concentration within the waste container to the receiver 114. The receiver 114 will then communicate the information to the administrator system 120. However, as will be described further below, a person skilled in the art will appreciate that any suitable information may be communicated to the receiver 114.

In one embodiment, each monitoring device 102, 104, 106 comprises a storage element for storing information. This has a particular advantage that information indicative of the detected gas concentration may be collected and stored over a period time before the information is transmitted to the receiver 114. For example, the gas sensor of a monitoring device may detect a gas concentration within the waste container multiple times per day, such as four times per day. Even if the receiver 114 only moves within the pre-defined distance relative to the monitoring device once a fortnight, it is possible to obtain information indicative of the gas concentration levels within the waste container for each day. This information may be analysed to obtain further insights, such as on the usage of waste containers. Furthermore, the inventors have found that a majority of power is consumed by the transmission of information. Thus, by storing information collected over a period of time on a storage element, battery life of the monitoring device may be extended.

Referring back to FIG. 1 in this example, the system 100 utilises the wireless communication technology LongRange (LORA) 124 for communications between the plurality of monitoring devices 102, 104, 106 and the receiver 114. Using LORA has the particular advantage that LORA has a relatively low power usage. In addition, LORA may additionally have geolocation capabilities so that the system 100 can determine a real-time position of each of the monitoring device 102, 104, 106 and the associated waste containers 108, 110, 112. A person skilled in the art will appreciate that the system 100 may utilise any suitable wireless communication technologies, including but not limited to Internet, Bluetooth, near field, Wi-Fi, RFID, and radio frequency.

Each monitoring device 102, 104, 106 may continuously transmit a signal such that when the receiver 114 moves within the pre-defined distance, such as the reach of the transmitted signal, the receiver 114 can detect and identify the monitoring device 102, 104, 106. The receiver 114 may then request the information indicative of the gas concentration and any other suitable information from the monitoring device 102, 104, 106. However, a person skilled in the art will appreciate that each monitoring device 102, 104, 106 may continuously transmit the information indicative of the gas concentration that is automatically received by the receiver 114 when the receiver 114 is within reach.

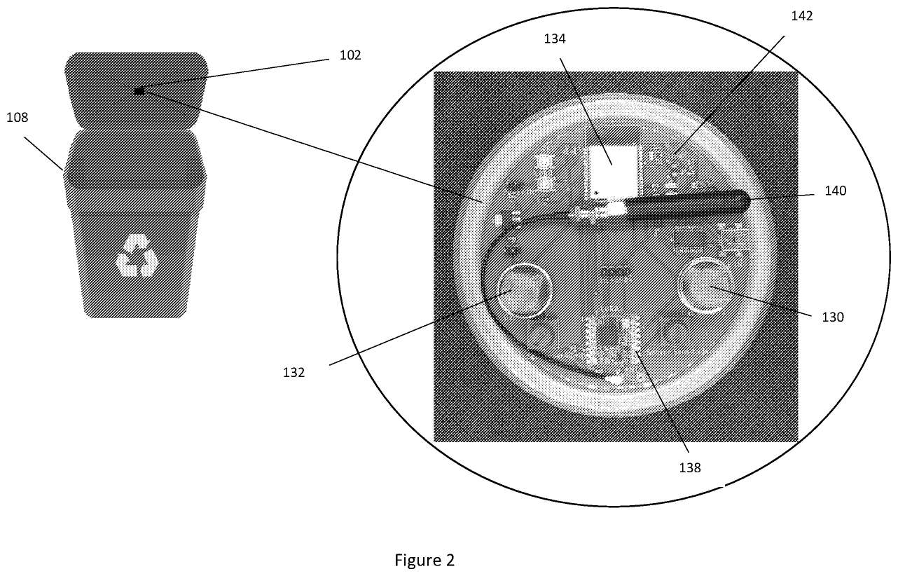

Referring now to FIG. 2, there is shown an exemplary monitoring device 102 mounted to a lid of a recycling waste container 108. In this particular example, the monitoring device 102 comprises a first gas sensor 130 for determining a concentration of a first gas within the waste container 108, and a second gas sensor 132 for determining a concentration of a second gas within the waste container 108. Specifically, the first gas sensor 130 is configured to detect a concentration of methane within the waste container 108 and the second gas sensor 132 is configured to detect a concentration of oxygen within the waste container 108. A person skilled in the art will appreciate that the gas sensors 130, 132 may be any suitable type of gas sensors, including but not limited to a combustible gas sensor, a photoionisation detector, an infrared point sensor, an ultrasonic sensor, an electrochemical gas sensor, a semiconductor sensor and an infrared imaging sensor.

If a concentration of methane within the waste container 108 exceeds a predetermined threshold, it may be an indication that food or bio waste is contained within the waste container, and that the waste container 108 is contaminated. Similarly, if a concentration of oxygen within the waste container 108 falls below a predetermined threshold, it may be an indication that the recycling waste container is contaminated. A person skilled in the art will appreciate that any suitable number and types of gases may be detected within the waste container.

In this particular example, the monitoring device 102 further comprises a controller 136 and a network interface in the form of a Long-Range (LORA) module 138 that is connected to an antenna 140. As briefly mentioned above, LORA typically has geolocation capabilities and may therefore be used to determine a real-time position of the monitoring device 102 and therefore the waste container 108. However, a person skilled in the art will appreciate that the monitoring device 102 may further comprise a geolocation component to determine a real-time position of the waste container. Such geolocation component may utilise any suitable positioning method to determine a real-time position of the waste container, including but not limited to GPS, WiFi and Bluetooth.

The monitoring device 102 in this example further comprises a distance sensor 142 configured to detect a distance from the distance sensor 142 to the content within the waste container 108. The distance sensor 142 in this particular example is in the form of a light detection and ranging (LIDAR) sensor 142. A LIDAR sensor typically comprises a light source for emitting light to the content within the waste container and a detector for detecting light reflected by the content. The detected light is then used to determine a distance from the sensor to the content. A person skilled in the art will appreciate that LIDAR sensors are well understood in the art and will not be described in further detail in this application.

By detecting a distance from the LIDAR sensor 142 to the content within the waste container 108, the system 100 may determine information indicative of a fill level of the waste container 108. Additionally, the system 100 may use the detected distance to determine whether the lid 103 of the waste container 108 is substantially closed. This is particularly advantageous in combination with detecting a gas concentration within the waste container 108 as an open lid may have an impact on the accuracy of the gas detection. Specifically, if the lid 103 of the waste container 108 is open, the system 100 may falsely determine that the detected gas concentration within the waste container 108 does not exceed or fall below the pre-determined threshold. This may have the consequence that a waste collection vehicle collects a contaminated waste container which may contaminate the entire waste collection.

If the system 100 determines that the lid 103 of the waste container 108 is not sufficiently closed, the system 100 may automatically make this information available to the driver computing device 121 associated with the waste collection vehicle. A driver of the waste collection vehicle may leave the waste container 108 uncollected and the system 100 may communicate information of the non-collection to the household computing device 123 associated with the waste container 108.

Furthermore, by determining information indicative of the fill level of the waste container 108, the system 100 may determine a time and/or frequency of the lid of the waste container 108 being opened. Specifically, a detected difference in fill levels within the waste container 108 may indicate that the lid of the waste container 108 was lifted between these two measurements.

In a particular example, the system 100 may use the detected distance by the distance sensor 142 to determine a shape of a content item within the waste container 108. Specifically, information indicative of the detected distance by the distance sensor 142 may be collected and communicated to the administrator system 120 where the information can be further processed. For example, information indicative of the shape of a content item may be used to identify the content item or a property associated with the content item, such as a material or a type of the content item. In this regard, the administrator system 120 may use a learning algorithm to identify the content item or the property associated with the content item within the waste container 108.

The monitoring device 102 may comprise an additional network interface, such as a WiFi module (not shown) for enabling direct communication with the administrator system 120. This has the particular advantage that specific information, such as information indicative of the fill level of the waste container, may be directly communicated to the administrator system 120 for further data processing. For example, the administrator system 120 may use the information indicative of the fill level of the waste container to generate a dynamic route for the waste collection vehicle. Furthermore, this embodiment may be advantageous for a specific application in which grease containers are monitored for a level of contamination. An exemplary system for this application which will be described in further detail below.

The monitoring device 102 further comprises a power source (not shown) for providing power to the gas sensors 130, 132, the controller 136, the LORA module 138, the antenna 140 and the LIDAR module 142. Suitable power sources may include but are not limited to one or more batteries and one or more solar cells. In a specific embodiment, the monitoring device 102 may comprise one or more solar cells that are connected to a primary battery that can be charged through the one or more solar cells. The monitoring device 102 may further comprise a secondary battery that provides power in case the primary battery fails or is not charged.

Referring back to FIG. 1, the receiver 114 in this example comprises a processor, a network interface and a memory. The receiver 114 has the function of receiving information from the plurality of monitoring devices 102, 104, 106 and transmitting them to one or more remote computing devices via the Internet 122, for example to the administrator system 120 for further processing. Once the information has been processed by the administrator system 120, suitable information may be made available to the remote driver computing device 121 associated with the waste collection vehicle and/or the household computing device 123 associated with the household of the waste container 108. The receiver 114 in this example can be manufactured relatively small and may therefore be particularly advantageous if the receiver 114 is positioned stationary, such as on a lamp post, a cell tower or the like.

Another exemplary component of the receiver 114 may include a locating component, such as a GPS component. A person skilled in the art will appreciate that components of communications enabled computing devices are well understood and will not be described in further detail in the present application.

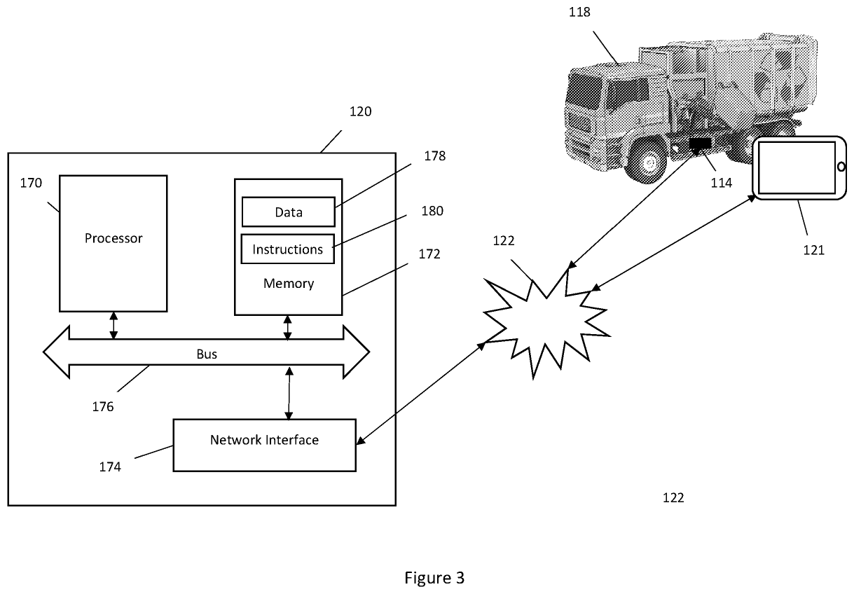

Referring now to FIG. 3, an example of a remote computing device, in this example of an administrator system 120 is schematically illustrated. The administrator system 120 is in the form of a computer server that includes a processor 170 configured to control and coordinate operations, a memory 172 and a network interface 174 that communicate with each other via a bus 176. The network interface 174 facilitates wireless communications between the administrator system 120 and the receiver 114 through the Internet 122.

The memory 172 stores instructions 178 and data 180 for the processes as described in the present application, and the processor 170 performs the instructions 178 from the memory 172 to implement the processes. It should be noted that although the administrator system 120 is shown as an independent network element, the administrator system 120 may alternatively be part of another network element, and functions performed by the administrator system may be distributed between multiple network elements.

As described above, in this particular example the administrator platform 120 receives information from the receiver 114 via the Internet 122 and may additionally or alternatively receive information directly from the plurality of monitoring devices 102, 104, 106. Using the received information, the administrator platform 120 may automatically trigger an action.

The administrator system 120 may further be configured to make information available to other remote computing devices such as the driver computing device 121 associated with the waste collection vehicle and/or the household computing device 131. In this regard, information received by the receiver 114 may be processed and transmitted using the network interface 174. Specifically, the administrator system 120 may be accessible by the remote computing devices 121, 123 through web pages served to the computing device 121, 123. This may be realised by software implemented by the processor, and through an application programming interface (API) that communicates with the computing devices 121, 123 using a dedicated application installed on the computing devices 121, 123. A person skilled in the art will appreciate that different information may be made available to the driver computing device 121 compared with the household computing device 123. For exemplary purposes, FIG. 3 only shows the driver computing device 121 associated with the waste collection vehicle.

In this example, the driver computing device 121 may also include a display and location-presentation resources to enable mapping or similar presentations using location information relating to the receiver 114 and the plurality of monitoring devices 102, 104, 106. For example, maps can be stored and/or retrieved from the memory to present the real-time location of the receiver 114 relative to the plurality of monitoring devices 102, 104, 106 and therefore the respective waste containers 108, 110, 112. The driver computing device 121 may also receive location information, such as routing information, from the administrator platform 120 via the network interface.

The display of the computing device 121 may additionally display any other suitable information, including but not limited to identification information, such as a name of the household associated with the waste container, an address of the household associated with the waste container, information indicative of a fill level of the waste container, information indicative whether the lid of the waste container is closed, and historical data.

In one example, if the controller of the monitoring device 102, 104, 106 or the processor 170 of the administrator system 120 determines that the detected gas concentration within a waste container exceeds or falls below a predetermined threshold, the administrator system 120 may automatically communicate a written warning to the household and/or issue a fine that is being communicated to the household associated with the waste container. This may be achieved by transmitting information to the household computing device 123.

For example, depending on the detected gas concentration and depending on whether it has been determined that the lid of the waste container is substantially closed, one of a plurality of actions may be automatically triggered by the administrator system 120. An action may for example be to automatically communicate a written warning to the household associated with the monitoring device, to issue a fine to the household associated with the monitoring device, non-collection of the waste container and/or to communicate a notification of the non-collection.

In addition, the administrator system 120 may use the information indicative of the fill level of the plurality of waste containers to dynamically generate a route for the waste collection vehicle. In this way, a more efficient route for the waste collection vehicle may be calculated which as a consequence may save time, fuel therefore operational costs for the waste collection management.

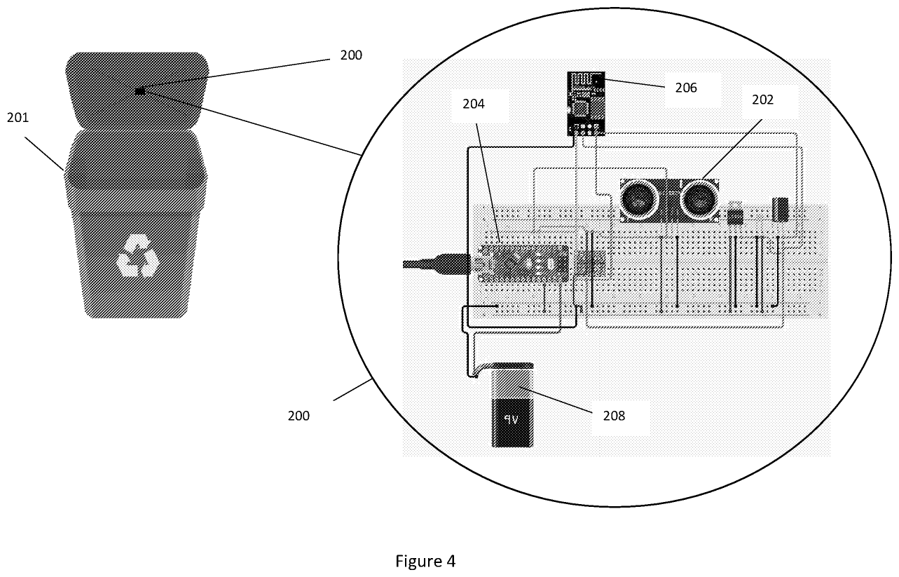

Referring now to FIG. 4, there is shown an alternative example of a monitoring device 200 in accordance with an embodiment of the present invention. The monitoring device 200 comprises a mount (not shown) for mounting the monitoring device 200 on a waste container 201, such as waste container 108, 110, 112. The mounting device 200 may be part of a system for monitoring content of one or more waste containers, similar to system 100 as shown in FIG. 1. The waste container 201 may be any waste container, including but not limited to a waste container for recycling waste, landfill waste or grease. In this particular example, the monitoring device 200 comprises a sensor 202 for detecting a distance from the sensor 202 to the content within the waste container 201 such as information indicative of a fill level of the waste container can be determined. The sensor in this example is in the form of an ultrasonic distance sensor 202. An ultrasonic distance sensor 202 typically comprises a transducer for emitting ultrasonic sound waves and detected sound waves reflected by the content within the waste container. A person skilled in the art will appreciate that ultrasonic distance sensors are well understood in the art and will not be described in further detail in the present application.

The monitoring device 200 further comprises a controller 204 and a network interface 206 connected to the controller 204. The controller 204 in this example is an Arduino Nano and is configured to determine the information indicative of the fill level of the waste container using the detected distance by the ultrasonic sensor 202. However, a person skilled in the art will appreciate that other suitable controllers, such as micro processors, are envisaged. The network interface 206 in this example is in the form of a WiFi module.

The monitoring device 200 in this example is configured to transmit the information indicative of the fill level of the waste container via the WiFi module 206 directly to the administrator system 120 via the Internet 122. This has the advantage that the system administrator system 120 may determine in real-time whether a waste container needs to be collected based on the determined fill level. For example, if the determined fill-level of the waste container exceeds a predetermined threshold, information indicative of the fill level may be communicated to the administrator system 120 to calculate a dynamic route for the collection of waste by the waste collection vehicle 110. A person skilled in the art will appreciate that the information indicative of the fill-level may be transmitted to the administrator system 120 via the receiver 114.

Similar to the monitoring device 102, the monitoring device 200 may further comprise one or more gas sensors (not shown) for detecting a gas concentration within a waste container.

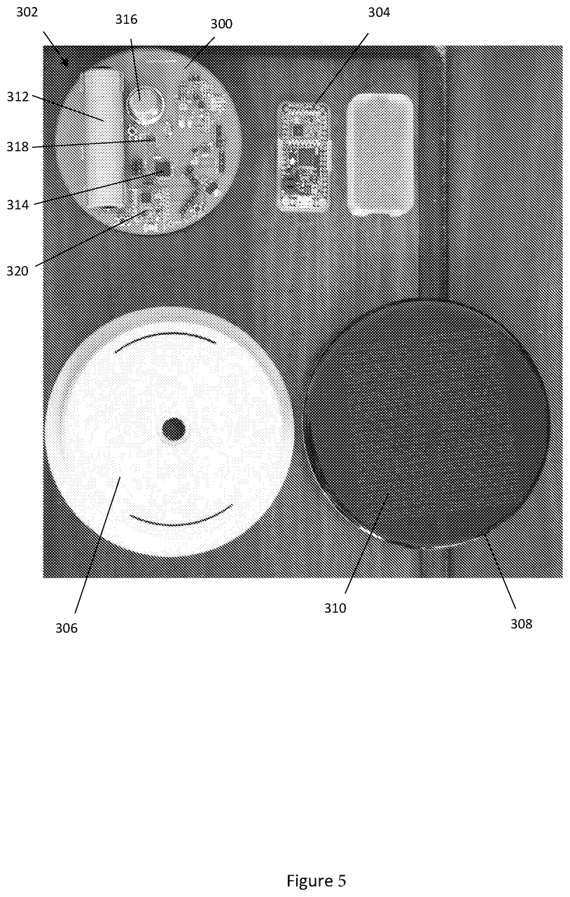

FIG. 5 shows illustrative components of a system for monitoring content of a waste container such as system 100. Specifically, FIG. 5 shows a circuit board 300 with main components of an exemplary monitoring device 302. FIG. 5 further shows a receiver 304 similar to receiver 114, a first housing part 306 and a second housing part 308 comprising a solar cell 310 as a power source for the monitoring device 302. The circuit board 300 supports a battery 312 for storing power generated by the solar cell 310, a processor and storage element 314, a gas sensor 316, and a distance sensor 318. As network interface, the circuit 300 further supports a low frequency high range radio transmitter 320 to enable communication with the receiver 304.

In order to mount the monitoring device 302 to a waste container, such as waste container 108, the circuit board 300 is positioned within the first housing part 306. The first and second housing parts 306, 308 are then connected to each other through a hole within the lid of the waste container such that a portion of the lid is positioned between the two housing parts 306, 308. In this way, the solar cell 310 can be positioned on an outer surface of the lid and the circuit board 300 is positioned on an inner surface of the waste container where the gas concentration and distance measurements are performed. In this example, the first and second housing parts 306, 308 are connected by a screw mechanism in combination with the application of an adhesive. However, a person skilled in the art will appreciated that any suitable manner of mounting the monitoring device to a waste container is envisaged. Referring now to FIG. 5, there is shown a flow chart illustrating a computer implemented method 500 of monitoring content of a plurality of waste containers in accordance with an embodiment of the present invention.

The method 500 comprises a step 502 of detecting a concentration of at least one gas within each of the plurality of waste containers. This step 502 is typically performed using a monitoring device having at least one gas sensor, such as monitoring device 102 or 200 mounted to an inner portion of each waste container. The gas being detected may be any suitable gas that indicates that the waste container is contaminated. In a further step 504, a distance from the monitoring device to the content within each of the plurality of waste containers is measured. For this step, the monitoring device may comprise a suitable sensor, such as a LIDAR sensor or an ultrasonic sensor.

Information indicative of the at least one gas concentration and the detected distance to the contain within the waste container are automatically communicated 506 via a networking interface to a receiver when the receiver is within a pre-defined distance to the waste container. The information may be the raw data collected by the sensors of the monitoring device. However, a person skilled in the art will appreciated that the monitoring device may further comprise a controller for further processing the data. For example, the controller may determine whether the detected gas concentration exceeds or falls below a pre-determined threshold. Furthermore, the controller of the monitoring device may determine a level of contamination within the waste container. The receiver may, for example, be mobile computing device mountable to a waste collection vehicle. The information may be communicated on demand, periodically or continuously.

The method further comprises a step 508 of determining information indicative of a fill level of a waste container using the detected distance, and a step 510 of determining whether the detected concentration of the at least one gas within the waste container exceeds or falls below a pre-determined threshold. This step may be performed by a computer server, such as the administrator system 120 or by the monitoring device itself. An action may then be automatically triggered 512 using the detected gas concentration and the information indicative of a fill level of a waste container.

In one specific embodiment (not shown), there is provided a system for monitoring content of one or more waste containers, such as waste containers collecting landfill. The system comprises a monitoring device comprising a gas sensor for detecting a concentration of at least one gas within a waste container, a controller in communication with the gas sensor and configured to determine whether the detected concentration of the at least one gas exceeds or falls below a predetermined threshold, and a network interface. The system is configured such that when the monitoring device is mounted to a respective waste container and the controller of the sensor device determines that the detected concentration of the at least one gas within the waste container exceeds or falls below the pre-determined threshold, the controller automatically communicates via the network interface information indicative of the detected gas concentration within the waste container to a remote control system.

This embodiment may be particularly advantageous for waste containers that are not monitored regularly, such as public waste containers collecting land fill. In this regard, the detected gas concentration being above or below a pre-determined threshold may indicate that the waste container emits an unpleasant smell. By automatically communicating this information to a control system, an action may be triggered, such as the collection of the content within the waste container. It should be noted that the monitoring device may be mounted anywhere on the waste container.

In a further embodiment (not shown), there is provided a system for monitoring content of a grease trap. Grease traps are typically used to collect solids, such as food waste, and greases before they enter a wastewater disposal system. Conventionally, in order to further utilise the grease, a sample of the grease within a grease trap is collected to be analysed for bacteria formation. If the bacteria formation is too high, the grease may only be utilised as compost. However, if the bacteria formation is below a predetermined threshold, other applications of the grease may be possible, such as for biodiesel or the like.

Similar to the monitoring systems described above, the system for monitoring content of a grease trap comprises a monitoring device that is mountable to the grease trap. The monitoring device comprises a gas sensor for detecting a concentration of at least one gas within the grease trap such as oxygen, a controller in communication with the gas sensor and a network interface. The system is configured such that information indicative of the detected gas concentration is communicated via the network interface to a remote computing device for further processing. Specifically, the detected gas concentration within the grease trap may be indicative of the level of bacteria formation. A correlation of data may be determined by comparing the detected gas concentration with a content sample that has been analysed in the laboratory. This has the particular advantage that by obtaining information on the level of bacteria formation, it is possible to control the bacteria formation in real-time. For example, bacteria formation may be suppressed by adding an additive to the grease trap thereby lowering or maintaining the current level of bacteria within the content. It will be appreciated by persons skilled in the art that numerous variations and/or modifications may be made to the invention as shown in the specific embodiments and/or aspects without departing from the spirit or scope of the invention as broadly described. For example, it will be apparent that certain features of the invention can be combined to form further embodiments. The present embodiments and aspects are, therefore, to be considered in all respects as illustrative and not restrictive. Several embodiments are described above with reference to the drawings. These drawings illustrate certain details of specific embodiments that implement the systems and methods and programs of the present invention. However, describing the invention with drawings should not be construed as imposing on the invention any limitations associated with features shown in the drawings.

1. A system for monitoring content of a waste container, the system comprising:
at least one monitoring device comprising a gas sensor for detecting a concentration of at least one gas within a waste container, the at least one monitoring device further comprising a controller in communication with the gas sensor and a network interface;
wherein the system is configured such that when the at least one monitoring device is mounted to the waste container, the controller of the monitoring device is configured to communicate information indicative of the detected gas concentration within the waste container via the network interface to a remote computing device such that the system can determine whether the detected concentration of the at least one gas within the waste container exceeds or falls below a pre-determined threshold.

2. The system of claim 1, wherein the at least one monitoring device further comprises a distance sensor to detect a distance from the distance sensor to the content within the waste container, and wherein the system is configured to determine a fill level of the waste container using the detected distance.

3. The system of claim 1, wherein the at least one monitoring device is associated with identification information and the system is configured to communicate the identification information associated with the monitoring device to the remote computing device.

4. The system of claim 3, wherein the identification information comprises a unique identifier, a name of a household associated with the monitoring device and/or an address of the household associated with the monitoring device.

5. The system of claim 1, wherein the gas sensor is configured to determine a concentration of at least methane within a waste container.

6. The system of claim 1, wherein the gas sensor is configured to determine a concentration of oxygen within a waste container.

7. The system of claim 2, wherein the system is configured to determine whether a lid of the waste container is closed using the detected distance from the distance sensor to the content within the waste container.

8. (canceled)

9. (canceled)

10. The system of claim 1, wherein the network interface of the at least one monitoring device comprises a Long-Range (LORA) module.

11. The system of claim 1, wherein the at least one monitoring device comprises a mount for mounting the monitoring device to an inner portion of a lid of the waste container.

12. The system of claim 1, wherein the at least one monitoring device further comprises a power source to provide power to the one or more sensors, the controller and the network interface.

13. The system of claim 12, wherein the power source comprises one or more solar cells that are mountable on an outer surface of the waste container.

14. The system of claim 1, wherein the system is configured to determine a level of contamination within the waste container using the detected concentration of the at least one gas within the waste container.

15. The system of claim 1, wherein the at least one monitoring device comprises a temperature sensor for detecting a temperature within the waste container.

16. The system of claim 1, comprising at least one receiver configured to receive information from a monitoring device that is located within a pre-defined distance from the receiver, wherein the system is configured to facilitate wireless communication between the at least one monitoring device and the at least one receiver.

17. The system of claim 16, wherein the receiver is mounted to a waste collection vehicle and the system is configured such that information indicative of the detected gas concentration within the waste container is automatically communicated from the at least one monitoring device to the receiver when the receiver is within the pre-defined distance.

18. The system of claim 1, wherein when the system determines that the detected gas concentration exceeds or falls below the pre-determined threshold, the system is configured to automatically trigger one of a plurality of actions.

19. The system of claim 1, comprising a plurality of monitoring devices, each being mounted to a respective waste container.

20. A monitoring device for monitoring content of a waste container, the monitoring device comprising:
a mount for mounting the monitoring device to the waste container;
a gas sensor for detecting a concentration of at least one gas within the waste container;
a controller in communication with the gas sensor;
a power source for providing power to the controller;
wherein the monitoring device is configured such that the controller processes the detected concentration of the at least one gas by the gas sensor to determine whether the detected concentration of the at least one gas within the waste container exceeds or falls below a pre-determined threshold.

21. A computer implemented method of monitoring content of a waste container, the method comprising:
detecting a concentration of at least one gas within the waste container using a monitoring device mounted to the waste container;
communicating via a network interface of the monitoring device information indicative of the at least one gas concentration to a remote computing device; and
determining whether the detected concentration of the at least one gas within the waste container exceeds or falls below a pre-determined threshold.

22. A software application for monitoring content of a waste container, the software application when executed on a computer system performing the steps of the method of claim 21.

23. (canceled)
